(19) United States
(12) Patent Application Publication
(10) Pub. No.: US 2026/0017025 A1
(43) Pub. Date: Jan. 15, 2026

(54) END-TO-END VERIFIED TRUSTED EXECUTION ENVIRONMENTS

(71) Applicant: CARNEGIE MELLON UNIVERSITY, Pittsburgh, PA (US)

(72) Inventors: AMIT VASUDEVAN, Pittsburgh, PA (US); FARZANEH DERAKHSHAN, Pittsburgh, PA (US); ZICHAO ZHANG, Pittsburgh, PA (US); LIMIN JIA, Pittsburgh, PA (US)

(73) Assignee: CARNEGIE MELLON UNIVERSITY, Pittsburgh, PA (US)

(21) Appl. No.: 18/862,298

(22) PCT Filed: Jan. 30, 2024
(86) PCT No.: PCT/US2024/013463

§ 371 Date: Nov. 1, 2024

Related U.S. Application Data
(60) Provisional application No. 63/442,226, filed on Jan. 31, 2023.

(51) Int. Cl. G06F 8/30; G06F 8/41; G06F 9/445; G06F 11/3604; G06F 21/57

(52) U.S. Cl. CPC G06F 8/30; G06F 8/41; G06F 9/44589; G06F 11/3604; G06F 21/57

(57) ABSTRACT

Disclosed herein is a formalized programming framework using memory compartmentalization and other properties of certified compilers to provide that security guarantees verified at the source level also hold on the compiled code. A trusted execution environment formulated as a collection of objects that access separate memory locations and conform to a public interface.

### RELATED APPLICATIONS

This application claims the benefit of U.S. Provisional Patent Application No. 63/442,226, filed Jan. 31, 2023, the contents of which are incorporated herein by reference.

### GOVERNMENT INTEREST

This invention was made with U.S. government support under contract FA8702-15-D-0002, granted by the Air Force Life Cycle Management Center (AFL-CMC). The U.S. government has certain rights in this invention.

### BACKGROUND OF THE INVENTION

Trusted Execution Environments (TEE) form the highest, privileged software component. They can be found in the vast majority of embedded platforms and encompass BIOSes, and firmware as well as TEE OSes and hypervisors, with wide application domains ranging from mobile environments, smartphones, wearables, and low-end Internet-of-Things to servers and industrial control systems. TEEs are a key security mechanism used to protect the integrity and confidentiality of applications on a majority of commodity computing platforms by enabling the execution of privileged and security-sensitive applications inside protected domains isolated from the operating system (OS) of the platform.

On some platforms TEEs leverage certain hardware mechanisms for their functionality (e.g., Intel SGX on x86 and ARM Trustzone). Subversion of a TEE gives the attacker full control of the entire platform because the TEEs are the highest privilege operating software.

Formal verification of TEEs can remove many of the vulnerabilities. However, verifying safety critical software such as TEEs for their functional correctness has not found practical widespread use, despite the progress made in producing formally verified kernels. This is due to the prohibitively high cost of verification in terms of dollars, time, and developer expertise. On the other hand, there have been several approaches targeting formally verified TEEs with a focus on practicality, such as XMHF, uberXMHF, Security Microvisor, and Contiki. These projects focus on specific security properties in lieu of full-functional correctness, with the goals of being development friendly and using automated verification tools at the source level. However, a significant shortcoming of using source-level verification tools is the lack of guarantees on the compiled code.

### SUMMARY OF THE INVENTION

As disclosed herein, memory compartmentalization and other properties of certified compilers can be used to prove that the guarantees verified at the source level also hold on the compiled code. A formalized programming framework is disclosed based on prior work that advocates programming systems like TEEs as a collection of objects, called u-objects (disclosed in U.S. patent application Ser. No. 17/683,786, filed Mar. 1, 2022) that access separate memory locations and conform to a public interface. A concrete notion of u-objects was first introduced as the building block of an architecture for building extensible hypervisors to ensure the hypervisor's memory integrity at the source level. A u-object, as illustrated in FIG. 1, is a programming compartment (or module) with exclusive access to a memory region and other system resources (e.g., CPU control registers, devices).

This invention takes the abstraction of u-objects one step further and shows: (1) if at the source level u-objects are shown to respect their interface (i.e., respect memory separation and the rely-guarantee conditions of all u-objects), then each u-object can be verified separately, and the compositional concurrent multi-core run of them satisfies the same properties; and (2) certain properties verified at the source level also hold on the compiled code if a certified compiler with compositional properties is used. These properties not only include standard assertions at function return points but also information flow properties between u-objects (i.e., compartments do not interfere with each other).

Compared to prior art efforts, disclosed herein is an abstraction that is liberated from a specific programming language and architecture (software and hardware), with an abstract semantics that models concurrent execution of u-objects in the context of multiple CPU cores and interrupts. This approach allows decomposition of verification of compiled code into source-level verification and using verified compilers that can preserve the verified source-level properties, and thus enabling more practical use of disparate off-the-shelf formal verification tools to obtain end-to-end properties on existing commodity TEEs.

This disclosure provides a general model for u-objects as units of memory compartmentalization and defines a locally verifiable predicate to ensure each compartment respects its interface. The model enjoys compositional verification at the source level: verifying the local predicate for each compartment carries over to the concurrent multi-core executions with interrupts. Compartmentalization also allows the enforcement of coarse-grained noninterference property easily. Certain types of assertions and the noninterference property can be carried over to the binary level by using a suitable compiler. End-to-end security guarantees on existing TEEs can be achieved by building a practical, decoupled, tool-chain that leverages existing certified compilers and off-the-shelf verification tools.

### BRIEF DESCRIPTION OF THE DRAWINGS

FIG. 1 is an illustration of a u-object.

FIG. 2 is a block diagram illustrating an overview of the formal framework.

FIG. 3 is a listing of the syntax for u-objects.

FIG. 4 is a block diagram illustrating the memory model.

FIGS. 5A-5B is a listing of the abstract semantics for selected rules.

FIG. 6 is an illustration of several scenarios showing the “respecting the interface” property.

FIG. 7 is a listing that summarizes the requirements of respecting the interface required by the u-object architecture on the source code.

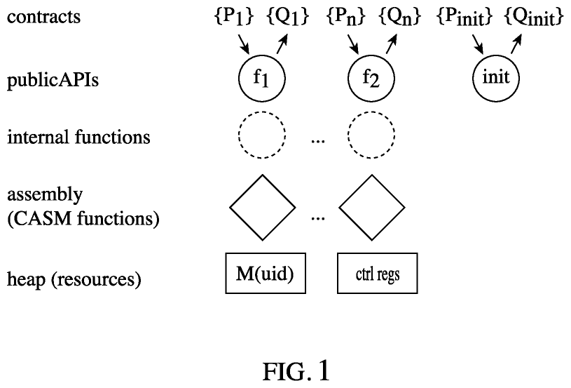

### DETAILED DESCRIPTION

The purpose of a TEE is to secure the execution of trusted applications (TA) s (trustlets) that turn within the protected TEE framework. TEEs are privileged software entities that typically rely on a small portion of dedicated hardware capabilities (e.g., enclaves, memory protection unit, virtualization) to boot-strap their execution and then setup required memory protections before running the (rich) guest OS.

A majority of the existing code-base software for TEEs and TA's is written in C and Assembly. The TEE programming language requirement is driven by having to: (a) interface with the OS kernel and device driver components which are mostly written in C for the majority of popular OSes, and (b) have low-level access to system resources including CPU critical registers, memory units, bus bridges, and devices. TEEs are generally assumed to be more secure than modern OSes due to the memory and privilege separation enforced via a combination of hardware and software mechanisms and their smaller software trusted computing base (TCB), which is several orders of magnitude smaller than standard OS.

However, TEEs and TA's have faced many exploits over the past years ranging from privilege escalation, buffer overflows, input validation errors, and integer overflows. This necessitates the formal verification of security properties on TEE and TA code-bases to achieve high assurance on the security posture provided by them.

### Framework for Compartmentalization

A u-object is a programming compartment (or module) with exclusive access to a memory region and other system resources (e.g., CPU control registers, devices, etc.). The public interface of a u-object consists of a collection of public application programming interface (API) declarations (pubAPIs), which can be called by other u-objects to access the guarded memory (and other resources) and can be restricted to a specific calling convention (e.g., based on their integrity labels). A distinguished public APL (init) sets up the u-object in a known-good initial state (e.g., initializes the u-object when it is loaded on a CPU core for the first time.) Each u-object has a set of internal functions not accessible from other modules. A u-object can also include Assembly functions.

Contracts—A u-object is accompanied by a behavior contract of its public interface in the form of pre- and post-conditions. The interface guarantees that if the precondition is satisfied upon invoking a public method, then the post-condition is guaranteed to hold upon return of that method.

Sequential vs. Concurrent—A u-object may be concurrent or sequential. The public methods of a concurrent u-object can be invoked in parallel on multiple CPU cores. In contrast, at most one core can invoke the methods of a sequential u-object at a time. In a concurrent execution with multiple cores, sequential u-objects enforce data race freedom via per-u-object locks. Data race freedom, which forbids two threads from accessing a location simultaneously when at least one of the accesses is a write, is an essential property for preserving the behaviors of source—level programs throughout the compilation process and cannot be guaranteed in the presence of concurrent u-objects. To enforce data race freedom while still supporting shared-memory concurrency, sequential u-objects guard a single resource.

Resources—The formalism disclosed herein models system resources that u-objects have exclusive access to as shared memory locations (heap). This includes the set of special control registers (e.g., interrupt control register and interrupt descriptor table register). Only the assembly functions in a u-object with exclusive access to a specified control register may read from or write to it

### CASM—Analyzing Assembly

For verification purposes, assembly code in u-object is written using CASM, a domain-specific language (DSL) using C functions to encode assembly instruction semantics. Such functions are referred to as CASM pseudofunctions. For example, for the x86 instruction “mov cr3” involving register “eax” there is a corresponding CASM pseudo-function called “ci_movl_eax_cr3”. Each CASM instruction pseudofunctions is defined in a hardware model (written in C) and models the corresponding CPU instruction (e.g., access to memory and to registers). During verification, each CASM instruction is replaced by the C source code from the hardware model. The resulting C-only program is verified for required properties (e.g., they respect their specifications and the specification of the other functions they interact with). CASM functions are also verified to respect the C application binary interface (ABT) and stack frames (e.g., not clobber callers registers or stack frames). During compilation, each CASM instruction is replaced by the corresponding assembly code.

### Certified Compilers

A common goal of certified compilers is to preserve the behaviors of source-level programs throughout the compilation process. Ensuring that the behaviors of a target-level execution are a refinement of the source-level execution. Originally, certified compilers (e.g., CompCert) only considered whole program compilation in which a closed program written in a single source language is compiled to a target language. To handle more realistic situations, CompCert has been generalized to apply to more modular settings. Compositional CompCert introduces a linking semantics to allow composition of different modules, each potentially written in a different language. Each source module is compiled separately, with potentially different compilers, to a corresponding target module. The target modules are linked with the same linking semantics. A local structured simulation is introduced based on a rely-guarantee condition that maps source-level memories to target-level memories to prove compiler correctness. CASCompCert uses a similar approach to address concurrency by providing a linking semantics that allows concurrent execution of multiple threads. The correctness proofs of both Compositional CompCert and CASCompCert assume that the source modules satisfy some properties. For example, CASCompCert, among a few other assumptions, requires that individual modules do not leak their stack pointers and that each source execution is data-race free.

### Formal Framework Overview

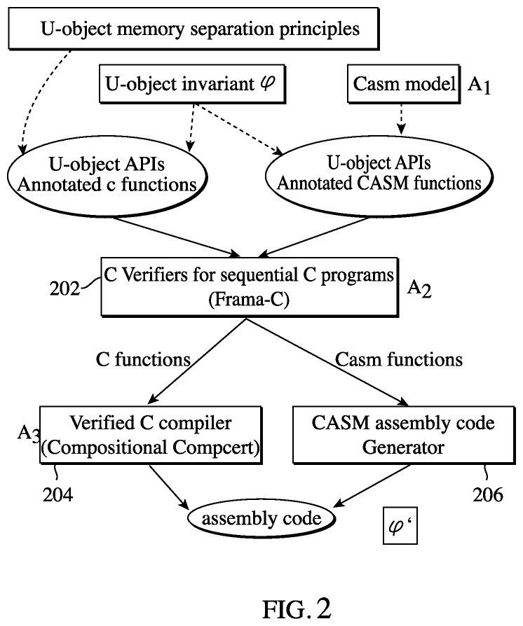

An overview of the formal framework and development flow that pushes verified guarantees at the source level to the compiled code will now be disclosed. The high-level development flow is shown in FIG. 2.

The verification results using a sequential verifier on u-objects comprising hypervisor source-code carry over to an execution environment where a sequential hypervisor supports a multi-core unverified guest OS. Using a certified compiler, results can be pushed down to compiled code. One goal of the disclosed embodiments is to allow developers to analyze safety-critical applications using this formal framework and to develop flow following a set of programming idioms outline below.

One aspect of this invention is to demonstrate via a formal framework that end-to-end security guarantees can be achieved in a more general setting, with interrupts and multiple CPU cores running verified u-objects, by leveraging results of certified compilers (e.g., CASCompCert).

The high-level development flow advocated by the disclosed formal framework is illustrated in FIG. 2. The three main components in the development flow are represented in rectangle boxes: a verification tool 202 for C (e.g., Frama-C), a certified C compiler 204 and an assembly code generator 206.

To analyze relevant properties, called u-object invariants (e.g., Direct Memory Access (DMA) protection is always turned on), the programs are annotated with directives that the analysis tool needs. For example, to use Frama-C's WP plugin, it is necessary to add specifications and assertions. The programming idioms dictated by the disclosed formal framework also are translated to annotations for the C analysis tool 202 to check. These are illustrated as the gray boxes on at the top of FIG. 2. The dashed lines indicate that these are manually translated into the annotations in the program. The high-level goal is to show that the u-object properties o′ (which is the low-level equivalent of the high-level invariant q) hold on the concurrent execution of the compiled assembly code, even though o is checked using a sequential C analysis tool on source code. Specifically, the principled shared memory accesses or separation of memory accesses can ease the verification process and that there is a set of assumptions (requirements) that must be placed on these tools for the reasoning to be sound.

Compiler Requirements—The disclosed invention provides an abstract criterion for compilers, independent of a specific source and target languages, that ensures that compiling each compartment separately preserves key source level properties, (i.e., memory separation and the specification of the u-objects) in any concurrent execution at the target (binary) level. For instance, a low-level requirement is that compilers preserve exclusive access to the specified control registers by not using them in the compilation process (e.g., via application binary interfaces (ABI) requirements). CASCompCert in particular, satisfies the required criterion.

Tool Compatibility Requirements—There are three categories of tool assumptions, denoted Aᵢ in FIG. 2. A₁: assume that the DSL semantics accurately reflect the assembly semantics. A₂: assume that the logic of C verifier 202 is sound (i.e., it only verifies correct predicates). A₃: assume that the C semantics used by the C analysis tool and the certified C compiler agree. The assumption is also made that the semantics of verified C compiler 204 for assembly is accurate.

Next, the method of discharging these assumptions and why they can be satisfied in practice is discussed. Assumption A₁ can be formally discharged by proving a simulation between CASM and Assembly. Given the small number of instructions used in implementing TEEs, testing-based validation suffices. Formal C-verifiers satisfy assumption A₂ by either providing a formal proof of their soundness (e.g., Verifiable C, or by proving a soundness result for some parts and describing the circumstances that may threaten soundness, for example, Frama-C). Assumption A₃ can be discharged when working with CompCert C compiler and C verification tools such as Verifiable C and Frama-C. The program logic in Verifiable C uses the same semantics as CompCert, and Frama-C agrees on the semantics of programs written in a subset of C, called Clight.

### Model Syntax and Semantics

The high-level schema in accordance with the present invention of a system of u-objects and their memory state are described and syntax and semantics governing their multi-core concurrent execution are introduced.

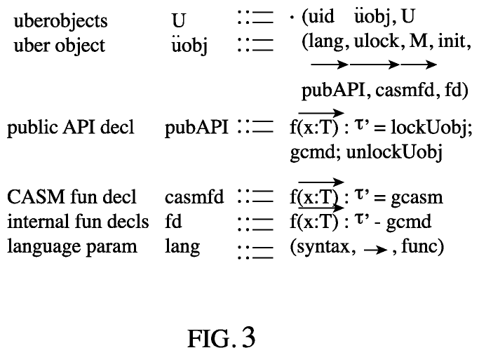

Model Syntax—The syntactic constructions for defining a u-object are summarized in FIG. 3. A system of u-objects, U, maps a unique identifier to a u-object, which is a tuple consisting of: (1) a language, lang, with which the u-object is implemented; (2) a lock, ulock, that ensures that the u-object can only run on one core at any time; (3) an exclusive region of the heap M owned by the u-object; (4) a public API, init, that sets up the initial state of the u-object; (5) a set of public APIs, pubAPI; (6) a set of CASM functions, casmfd; and (7) a set of internal function declarations, fd. A public API holds a lock on the memory when it is initialized and releases it only after it returns to avoid a data race.

Instead of modeling the detailed semantics of the source language (e.g., C for most TEE) or the target language (e.g., x86 assembly), it is assumed that each u-object takes in, as a parameter, the language (lang) in which it is implemented.

Generalized commands, gcmd, consist of commands in agreement with the syntax of the language in which the u-object is implemented (lang). CASM commands, gcasm, are assembly code for the target hardware architecture (e.g., x86) written in CASM DSL. For example, in a u-object uid with uid.lang=C, the functions declared in uid.pubAPI and uid.fd are implemented using commands in the C language, while the functions in uid.casmfd are implemented by CASM commands.

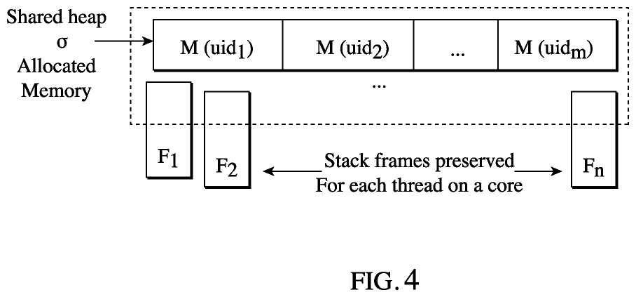

Memory Model—The layout of the memory for U, with m distinct u-objects, is illustrated in FIG. 4. The heap is compartmentalized into m separate memory locations uidᵢ.M for i≤m. Each heap compartment uidᵢ. M is a set of addresses defined as uidᵢ.M∈ [symbol] (Addr), such that for all i≠j≤m, uidᵢ. M∩uidⱼ. M=0.

The syntax for defining memory is summarized below. As illustrated in FIG. 4, the state model also includes the regions preserved for the stack frames (i.e., freelists), defined similar to their counterparts in CASCompCert.

$$Exclusive heap \qquad M ∈ 𝒫 ( Addr )$$

$$Freelist stream \qquad ℱ \text{::} = F , ℱ$$

$$\begin{matrix}Freelist & F ∈ {𝒫}^{ω}\end{matrix} ( Addr )$$

$$Memory state \qquad σ ∈ Addr ↦ val$$

A freelist can be infinitely large and is used by the thread to allocate its local stack locations as needed. It is assumed that a stream of such infinite freelists F is available upon request. The stream of freelists F, is a coinductive definition and consists of freelists of the type F∈ [symbol] (Addr) (i.e., infinite sets of memory addresses). It is assumed that all freelists F in the stream [symbol] are mutually disjoint from each other and from the heap locations. Memory state σ is defined as a mapping from the heap and the allocated parts of the stack to values.

Runtime Constructs—The runtime constructs consists of multiple CPU cores with the following syntax.

$$\begin{matrix}thread pool & T \text{::} = \cdot \vert tid ↦ 〈 uid , mainf , lang , F , ρ , a 〉 , T \\ single core state & k \text{::} = 〈 cid , T 〉 \\ multi core state & K \text{::} = 〈 ℱ ; σ ; k ; c i d 〉\end{matrix}$$

Each CPU core k, is a tuple of a unique core identifier cid and a list of threads T for executing external function calls. A single thread, uniquely identified with tid, consists of: (1) the main function mainf that initializes the thread and can either be a publicAPI or a CASM function; (2) language of the thread lang. If mainf is a CASM function then lang is CASM and otherwise it is the language of uid; (3) the freelist F allocated to the thread; (4) the current internal core state ρ of the thread storing key control flow state; and (5) the instance, a, that satisfied the precondition mainf when the thread was initialized. Each multicore state K consists of a stream of freelists [symbol] , a mapping from addresses to values, σ, a list of CPU cores and the active (running) core cid. The active core cid in a multicore state can switch non-deterministically.

Interface Specification—For each u-object uid∈dom(U) and every function ƒ∈uid.\vec{casmfd}∪uid\vec{pubAPI}, an interface {P(x)}uid.ƒ{Q(x)} is fixed and collected in the set Δᵤ. P(x) and Q(x) are pre- and post-conditions of the function ƒ, respectively. These are also referred to as uid.ƒ.pre(x) and uid.ƒ.post(x). These pre- and post-conditions are the behavior contracts of the interface. The memory footprint of the interface for the u-object uid is specified by (uid.M).

In line with function specifications in verifiable-C separation logic, the precondition uid.ƒ.pre(x) is defined to be parametric in x of type A and has a type A→Prop. A universally quantified version of it, ∀x: A.uid.ƒ.pre(x), is a first-order predicate defined over a global memory state σ (a pair of heap and stack where the heap includes other resources, e.g., control registers). σ|=uid.ƒ.pre(a) specifies that the memory a satisfies uid.ƒ.pre(x) when x is instantiated with the instance a. Assume that the predicate is only defined over the heap owned by uid. (i.e., σ|_{uid.M}). The same holds for uid.ƒ.post(x).

Moreover, for the sake of simplicity, assume that A has a simple base type (e.g., a list of integers or a string). For example, the specifications of the public API function foo owned by a u-object uid can be enforced:

$$f o o : = {l}_{1} = * {l}_{0}$$

where:

$$uid . M = \{ {l}_{0} , {l}_{1} \} ;$$

$$uid . pre . foo ( x ) := {l}_{0} x ;$$

$$and$$

$$uid . post . foo ( x ) := {l}_{1} x$$

### Local Syntax and Semantics

The language parameter, lang, of a u-object dictates the syntax of its public API and internal functions and the semantics by which those functions evaluate. The syntax defines a grammar for commands, gcmd, and describes the internal states, ρ, that manage the local control flow inside a function and the internal call stack (e.g., control continuations).

A pair of a memory state, σ, and an internal state, p, describes the program state. The semantics . . . → defines a local transition migrating a program state of the form σ, ρ with respect to a given freelist F:F∥ . . . σ,

$$ρ \to {}_{ι}^{δ}$$

σ^{l}, ρ^{l}. The label δ indicates the footprint (read and write set) of this step; when δ is empty, it is omitted. The label l specifies the type of internal step: abt stands for a step that results in an abort, ret stands for function return, and τ stands for effectless internal steps.

The internal and external calls are distinguished as follows: a general command defining a function in its public APIs (pubAPI), or internal functions (\vec{fd}) can make (a) an internal call to the functions defined in fd of the same u-object; (b) an external call to the CASM functions declared in \vec{casmfd} of the same u-object; or (c) an external call to a public API of another u-object. A CASM command defining a function in \vec{casmfd} may make an internal call to the functions defined in casmfd of the same u-object, or an external call to a public API of another u-object. A u-object makes internal steps with internal calls. When an external call is made, it cannot take internal steps until the external call returns.

The final element of lang, the set func includes four functions for initializing the internal state (initCore) and governing transitions related to external calls and returns (extCall, extRet, and halt). The function extCall is called when an external call is made, extRet is called when an external call returns, and halt is called when the current thread is ready to return to its caller. The semantics of a language specifies the behavior of these four functions as follows: F∥−initCore(ƒ\vec{v})=ρ initializes a core given a public API of a u-object or a CASM function ƒ on arguments \vec{v} consulting the declarations in the u-object that owns them.
F∥—extCall (ρ)= [symbol] ƒ\vec{v}, ρ′ [symbol] returns a pair [symbol] ƒ\vec{v}, ρ′ [symbol] when ρ calls an external function ƒ with arguments \vec{v} and puts ρ to a waiting state ρ′.
F∥—extRet(ρ, v)=ρ′ updates ρ, waiting for the return of an external call, to a new state ρ′, with a return value v.
F∥—halt(σ, ρ)= [symbol] v, p′ [symbol] returns p′ and a return value v iff F∥—σ, ρ→ᵣₑₜ σ, ρ′ with the global memory state o.

### Operational Semantics

The concurrent multicore semantic rules are of the form

$$〈 ℱ ; σ ; \vec{k} ; c i d 〉 ⇒ {}_{ι}^{δ} 〈 {ℱ}^{′} , {σ}^{′} , \vec{{k}^{′}} , {cid}^{′} 〉 .$$

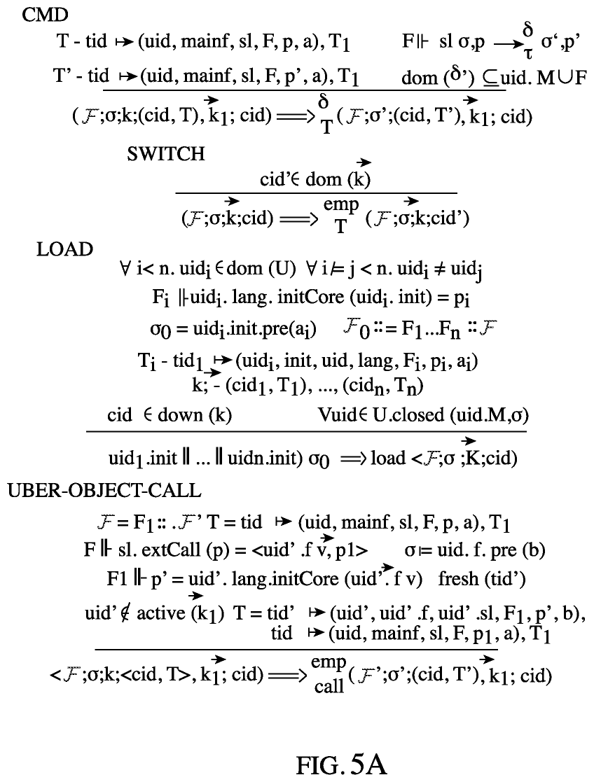

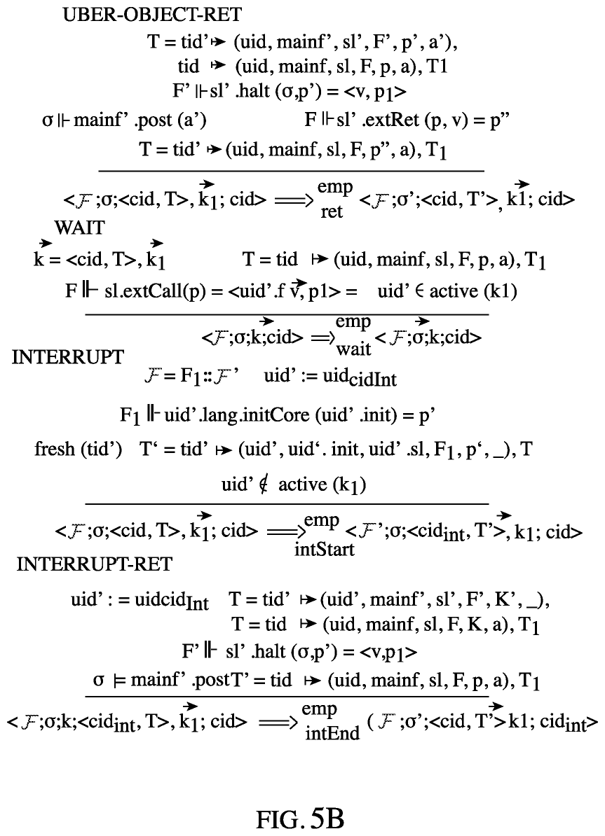

The δ is inherited from the underlying local internal steps and refers to read/write footprints of the step. The label l is still used to specify the type of multicore step. For instance, load stands for loading a configuration, call stands for an external call, and ret stands for return. Selected rules are summarized in FIGS. 5A-5B.

The execution of a program on a system with n distinct cores and an initial global state memory σ₀, starts with a configuration, C, of the form (uid₁·init∥ . . . ∥uidₙ·init)_{σ}_{ₒ}, where σ₀ assigns initial values to the heap locations. A configuration is well-defined iff for all i≤n, uidᵢ∈dom(U) and for all i≠j≤n, uidᵢ≠uidⱼ. A well-defined configuration describes a system of u-objects ready to initialize n distinct u-objects on the cores by calling their init functions.

The rule LOAD takes care of this initialization: it (1) initializes the internal core state ρᵢ, for each uidᵢ, using the corresponding initCore function; (2) starts a new thread on each core; (3) assigns n disjoint freelists from [symbol] to each thread; and (4) checks that 0, satisfies the precondition of each u-object's main public API, uidᵢ·init.pre(x), for an instance aᵢ.instantiating x. These threads are run until they return (via one of the rules). At that point, it is necessary to ensure that the post-condition of the thread holds for the exact same instance aᵢ. Thus, instance aᵢ is carried in the thread to be used when checking the post-conditions.

Moreover, the load rule requires each heap compartment to be closed (i.e., closeduid.M, σ₀)) states that any pointer stored in an address in the domain of uid.M has to point to another location in uid.M. In other words, a heap compartment cannot store a pointer to another heap compartment or a stack frame. This property implies an instance of respecting borders on the heap: a function cannot find a pointer on its memory that points to a location not accessible to it.

The LOAD rule chooses a core identifier cid∈dom(\vec{k}) as the active core. The active core cid can be switched to any other cid′∈dom(\vec{k}) any time using the SWITCH rule, allowing modelling of a preemptive concurrent dynamics.

The rest of the semantic rules, except the last two handling interrupts, are defined based on the internal state of the top thread on the stack of the running core. For example, the CMD rule is fired when the top thread on the stack of the running core wants to take a local (τ) step. The rule ensures that the multicore state also steps accordingly. CMD asserts that the read/write footprint of the internal core state only touches the memory locations the thread has exclusive access to.

If the top thread on the stack of the running core calls a public API, the rule UBER-OBJECT-CALL (1) identifies the callee and the arguments passed to it using the function extCall; (2) updates the comment internal core state to wait for its callee to return; and (3) spawns a new thread on top of the core's stack, initializes its internal core state using the function initCore, and assigns a fresh freelist to it. It also checks that the call respects the specifications by ensuring that o satisfies the pre-condition of the callee for some b.

To avoid complications of implementing locks in the semantics, they are simulated by adding an extra condition on UBER-OBJECT-CALL that allows initialization of a public API of uid′ as a callee if uid′ does not appear anywhere on the stack of any of the cores in \vec{k₁} (i.e., uid′∉active(\vec{k₁})). If this criterion is not met. then the u-object already has the lock on a different core and thus the caller's thread needs to wait (using the WAIT rule) until the lock is released. Note that the implementation of locks may result in livelock (e.g., two u-objects may mutually wait for each other).

When the top thread on the stack of the active core halts: If there is at least one other thread on the stack waiting for its result, the rule UBER-OBJECT-RET uses the function extRet to update the internal core ρ based on the return value v. It also ensures that the post-condition of mainf′ holds for the argument a′. By construction, a′ is the same argument that satisfies the precondition of mainf′. If there is no other thread waiting on the core, the core is terminated.

Interrupts—Interrupts are modelled as an interrupt handler u-object for each core. For the core cid, the interrupt handler u-object uid_{cidInt} is appointed. As a u-object, uid_{cidInt} has its own assigned memory location, which consists of the core's interrupt description table and its interrupt flag, describing whether interrupts are allowed for the core or not. uid_{cidInt} has two distinct public APIs: init, and setCtx. Other u-objects may call the public API function setCtx to change the interrupt flag of the core.

The function init (which takes no arguments) checks whether interrupts are available for the core and, if so, it calls a public API of a u-object corresponding to the interrupt service routine. The preemptive model allows init to take control of the core at any point in time, assigning the highest priority to the interrupts. As a result, the init public API needs to have an always true pre-condition to ensure that it can always be initialized: uid_{cidInt}.init.pre=true.

The INTERRUPT rule models the preemptive semantics. To enforce the locks of u-u-objects, the extra premise uid′∉active(\vec{k₁}) is required. Thus, in this model, an interrupt cannot get interrupted. When the interrupt handler terminates, INTERRUPT-RET hands back the core to the original interrupted thread asserting the post-condition of the interrupt handler's init public API. This rule is similar to other return rules, except that the internal state of the interrupted thread is not updated after the return. As a result, this specific return must be distinguished from others (e.g., UBER-OBJECT-RET) A subscript, int, is assigned to the core cid, (i.e., cid_{Int}) when the interrupt handler of the core initializes (INTERRUPT), and it is removed it after it returns (INTERRUPT-RET).

### Theory

A set of theorems will now be presented that, when true, provide the result that the abstract compartmentalization disclosed herein yields the desired properties.

### Source-Level Composition of Compartments

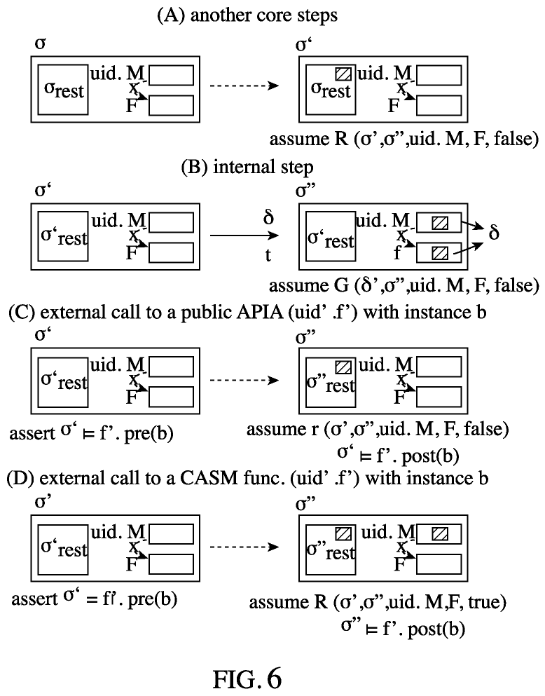

Properties verified of each u-object in isolation hold on concurrent executions of the whole system. To support this, the property of respecting the interface (i.e., respecting memory footprint boundaries and specified pre- and post-conditions) is shown in FIG. 6. A u-object respects the interface iff all of its public APIs and CASM functions respect the interface. A set of u-objects U respects the interface, if all uid∈U respect the interface.

A guarantee condition of a thread when it evaluates its own code can be defined. The guarantee condition G(δ, σ, F, M) holds iff M is closed with respect to o and the footprint δ only touches the memory regions in F and M (i.e., closed (M,σ)Λdom(σ)⊆F∪M). View (B) of FIG. 6 illustrates that each internal step of a thread must satisfy the guarantee condition.

Any step the thread takes asserts the guarantee condition: it does not leak any references and only changes its own heap and stack (View (B) of FIG. 6). Moreover, the step results in a new configuration that has the same property. Further, if the thread halts, its return value is not a pointer. In the case of an external call, the thread does not leak any pointers to the callee. Moreover, the caller can assume that its callee only extends the global memory according to the agreed-upon boundaries (Views B,C of FIG. 6). The state after the return continues to have the same property.

If each u-object respects the interface in isolation, any concurrent run of the whole system respects the interface. In particular, in any concurrent run, when a public API or CASM function returns, the global memory state satisfies the function's post-condition.

When all functions respect the interface, the core invariant is preserved in any concurrent execution. This result shows that under the conditions ensuring that a configuration initializes successfully, the core can always progress by taking a step other than SWITCH.
Theorem 1 (Preservation of the Invariant): If a system of u-objects U respects the interface, then every step of the abstract semantics, as shown in FIGS. 5A-5B preserves the core invariant.
Theorem 2 (Progress). If a system of u-objects U respects the interface and is valid with respect to a global memory state o, then the well-defined configuration (uid₁.init∥ . . . ∥uidₙ.init)_{σ}_{ₒ}, can be successfully initialized and every core in the compositional concurrent run of the configuration enjoys progress, i.e. every core can either take a step other than SWITCH or it terminates (with TERM, DONE, or ABORT).
Corollary 3 (Preservation of the Specs Globally). Consider a system of u-objects U that respects the interface and is valid with respect to a global memory state σ. In any concurrent execution of a well-defined configuration (uid₁.init∥ . . . ∥uidₙ.init)_{σ}_{ₒ}, if a thread on a core is ready to halt, then the post condition of the main function running on the thread can be established.
Theorem 4 (Data Race Freedom): Every well-defined configuration is data race free.

### Source-Level Secure Flow of Information

In one aspect of the modular verification, an interface is defined to ensure a non-interference property for the concurrent system. An integrity label is assigned to each memory compartment and an information flow calling convention is imposed on u-objects to ensure that the data stored in the low-integrity regions do not influence those with higher (or incomparable) integrity labels.

The non-interference result states that if two configurations agree upon the high-integrity initial u-objects and the high integrity memory locations, if one configuration can reach a state, the other one can simulate the execution and the resulting memory states still agree on the high integrity memory locations.

To simplify the non-interference statement, assume that all u-objects terminate and do not abort. The termination assumption is necessary for establishing the simulation. In a non-terminating setting, a low-integrity u-object in the second configuration may be trapped in an internal loop and cannot take the step required for completing the simulation. The assumption can be eliminated by proving termination. The majority of the u-object's functions that implement a TEE are short-running services without unbounded loops or recursion. The programmer can verify their termination either manually or using automated tools (e.g., the termination checker provided by Frama-C).
Theorem 5 (Noninterference): Consider an interface respecting system of u-objects U that adheres to the IF calling convention and is valid with respect to initial global memory states σ₀ and σ′₀. For any integrity level ξ∈Ψ, consider two well-defined configurations (uid₁.init∥ . . . ∥uidₙ.init)_{σ}_{₀}, and (uid′₁.init∥ . . . ∥uid′₁.init)_{σ}_{₀} s.t. ∀uid∈U. ∀l∈uid.M if uid⊆ξ, then σ₀(l)=σ′ₒ(l), and ∀i≤n with uidᵢ⊆ξ or uid′ᵢ⊆ξ, we have uidᵢ=uid′ᵢ. If one configuration reaches a state with global memory o, then the other one can simulate the execution and reach a state with global memory σ′ s.t. ∀uid∈U.∀l∈uid.M. If uid⊆ξ, then σ(l) or σ′(l).

### From Source to Target Level Property Preservation

The ultimate goal is to bring the source-level properties: preserving the specs and coarse-grained noninterference introduced herein to the target level. The idea is that a different compiler may be used for each u-object, but each has an identified set of requirements that must be satisfied.

These requirements are enough to preserve the property of respecting the interface for each compartment. Then the same abstract semantics of FIGS. 5A-5B are used to compose the compiled compartments for concurrent execution and use the same set of theorems used for the source level to establish the properties (e.g., progress), of the concurrent compositional run at the target level.

The properties required by a compiler to preserve the properties verified at the source-level to the target level will now be discussed. A compiler abstractly consists of a memory transformation function and a code transformation function. It is required that the memory transformation function of a compiler to be well defined in the sense that it preserves the disjointedness of the heap compartments from source to target. A target-level system of u-objects is obtained by compiling the source u-objects using a compiler with a well-defined memory transformation function. Next, the interface-preserving property of a compiler is defined that ensures that if a source-level u-object respects its interface then its target-level counterpart also respects the interface. If each u-object is compiled in isolation by an interface preserving compiler, then the concurrent execution of the target-level system of u-objects enjoys the same properties (i.e., preservation, progress, and data race freedom) as the source-level system of u-objects (Corollary 6). The definition of sequential compiler correctness is used to show that correct sequential compilers are interface preserving (Theorem 7).

For each u-object uid∈U in the source level, a corresponding u-object uidₜ is defined in the target-level. uidₜ owns the exclusive memory location MT(iod. M), which is the mapping of the uid's exclusive memory to the target level. It has the same set of function declarations with their code being translated to the target language a the code transformation mapping CT. The CASM functions are translated to the assembly language by an identity code transformation on their original assembly implementation.

Each target-level u-object inherits its integrity level and lock from its source-level counterpart. Recall that the lock is a conceptual lock, modeled by the WAIT rule in the semantics. The rest of the target-level u-object definitions are carried over from the source level similarly. A subscript “t” is used on the target-level entities to distinguish them from their source-level counterparts. A configuration in the target-level runs concurrently using the same semantic rules shown in FIGS. 5A-5B, with the minor exception that in the last premise of the CASM-CALL, we put the language of the new thread to ASM instead of CASM.
Corollary 6: Assume that each uid∈U is compiled with an interface-preserving compiler. If each uid∈U respects the interface, then every target-level configuration enjoys the global spec-preservation and the coarse-grained noninterference properties.
Theorem 7: Correct sequential compilers are interface-preserving.

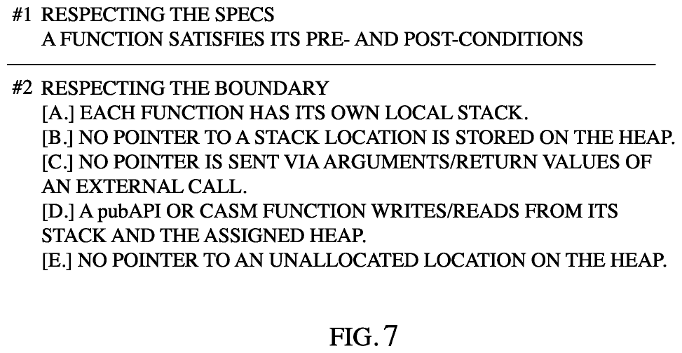

FIG. 7 summarizes the requirements of respecting the interface required by the u-object architecture on the source code.

For an uXMHF TEE, Requirement #1 of FIG. 7 is satisfied by uXMHF because pre- and post-conditions of every function are checked by deductive verification via Frama-C's WP plugin and value analysis. #2[a.] is satisfied via Frama-C's value analysis checks for memory separation of u-objects and function local stack in combination with the property that guarantees page tables are correctly initialized. Further, assertions on the source ensures memory reads and writes are within u-object's local memory and that no pointer to a stack location is stored on the heap (#2[b.]). When a verified u-object writes to the stack (e.g., via Assembly language), a corresponding hardware model callback function is invoked during verification which contains an assertion in the body of that function to check whether the stack pointer register has a valid address (within the prescribed stack frame; #2[d.]). Frama-C's AST analysis is used to ensure that function formal arguments cannot be pointer types (#2[c.]). Finally, #2[e.] is satisfied by uXMHF since neither dynamic memory allocation nor function pointers exists in the source. This is verified via Frama-C's Abstract Syntax Tree (AST) analysis. Moreover, Frama-C's value analysis on uXMHF proves the absence of invalid pointer dereferencing.

For a Trustzone TEE, Requirement #1 is satisfied by TZSMC because all assertions are checked by abstract interpretation via Frama-C's value analysis. Requirement #2 is satisfied via a combination of strategies. Assumptions #2[c.] and #2[e.] are satisfied via Frama-C's AST analysis and value analysis. To satisfy assumptions #2[a.], #2[b.], and #2[d.], a function call stack is modelled and code for verification is automatically generated. The hardware modeling also aids in ensuring correct stack frame preservation during execution and across function calls. Before a function call we have a function stack prologue that prescribes space for the current function call stack and set the address for the stack-pointer register in our hardware model. For every CASM instruction inside the CASM function, we check that the memory reads and writes are restricted to the current call stack and global variables and that no stack location is stored on the heap; this is achieved via the assertions inside a callback function. Furthermore, after each CASM instruction, an additional assertion is placed to check if the stack-pointer register has a valid address within the prescribed stack frame.

A formal model of compartmentalization for implementing TEEs has been disclosed herein. Compartmentalization allows the achievement of compositional verification results at the source level and enables leveraging of certified compilers to preserve the guarantees at the target level. This compartmentalization model was used at the source level on two existing open-source TEEs running on x86 and ARM platforms, and the security properties hold at the binary level if the code is compiled by CASCompCert.

As would be realized by one of skill in the art, the disclosed systems and methods described herein can be implemented by a system comprising a processor and memory, storing software that, when executed by the processor, performs the functions comprising the method. For example, the training, testing and deployment of the model can be implemented by software executing on a processor.

As would further be realized by one of skill in the art, many variations on implementations discussed herein which fall within the scope of the invention are possible. Specifically, many variations of the architecture of the model could be used to obtain similar results. The invention is not meant to be limited to the particular exemplary model disclosed herein. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A system for verifying a trusted execution environment programmed as a collection of abstract objects, comprising:
a verifier for sequential programs for verifying annotated application programming interface (API) functions of each abstract object and for verifying annotated CASM functions of each abstract object;
wherein the verifies outputs verified API functions and verified CASM functions;
a verified compiler for compiling the verified API functions into verified assembly code; and
an assembly code generator to generate verified assembly code from the verified CASM functions.

2. The system of claim 1 wherein the annotations of the API functions and the annotations of the CASM functions direct the verifier to check relevant properties of the API functions and the CASM functions that guarantee the trusted execution environment.

3. The system of claim 2 wherein assembly code in the object is written in CASM.

4. The system of claim 3 wherein CASM provides pseudofunctions corresponding to the assembly language of the object.

5. The system of claim 4 wherein the verifier replaces the CASM pseudofunctions with source code from a hardware model.

6. The system of claim 1 wherein each object comprises:
an identifier;
an indication of the language in which the object is implemented;
a lock that ensures that the object run on only one core at a time;
an exclusive region of memory;
an initialization API that sets initializes the object;
a public API;
a set of CASM functions; and
a set of internal function declarations.

7. The system of claim 6 wherein the CASM functions are assembly code for a target hardware architecture.

8. The system of claim 6 wherein the object guarantees that, for any method in the public API, if a pre-condition is met upon invoking a public method, a post-condition is guaranteed to hold upon return from the public method.

9. The system of claim 6 wherein method of the public API of concurrent objects can be invoked in parallel on multiple CPU cores.

10. The system of claim 6 wherein the exclusive region of memory includes exclusive access to one or more control registers.

11. A method of verifying a trusted execution environment at a compiled code level comprising:
programming the trusted execution environment as a collection of abstract objects exhibiting memory compartmentalization and verified interface conformance;
verifying the objects at a source level; and
compiling the objects using a verified compiler to produce verified compiled code.

12. The method of claim 11 wherein each object has a public API having one or more public methods;
wherein the public interface guarantees that if the pre-condition is met upon invoking a public method, a post-condition is guaranteed to hold upon return from the public method.

13. The method of claim 12 wherein programming the trusted execution environment further comprises:
annotating a public API of the object with directives enforcing memory separation principles.

14. The method of claim 13 further comprising:
annotating the public API and CASM functions of the object with directives enforcing one or more invariants to ensure the trusted execution environment.

15. The method of claim 14 further comprising:
applying a verifier to the annotated public API and CASM functions to interpret the directives and verify that the directives enforce a set of invariants.

16. The method of of claim 15 wherein the CASM functions comprise pseudofunctions corresponding to the assembly language of the object.

17. The method of claim 16 wherein the verifier replaces the CASM pseudofunctions with source code from a hardware model.

18. The method of claim 15 wherein the verifier outputs verified functions, further comprising:
inputting the verified functions to a verified compiler to produce assembly code.

19. The method of claim 18 wherein the verifier outputs verified CASM functions, further comprising:
inputting the verified CASM functions to aa CASM assembly code generator to produce assembly code.

20. A system comprising:
a processor; and
memory, storing software that, when executed by the processor, cause the system to perform the method of claim 11.

21. The method of claim 15 wherein the object satisfies a set of invariants, wherein the set of invariants comprises:
all functions within the object satisfy one or more pre- and post-conditions;
all functions within the object has an associated local stack;
pointers to locations in the local stack are not stored on a heap;
pointers are not sent via arguments or return values of external calls;
a pubAPI or CASM function writes and reads from the associated local stack and an assigned heap; and
pointers never point to an unallocated location on the heap.
